(19) United States
(12) Patent Application Publication
(10) Pub. No.: US 2006/0177225 A1
(43) Pub. Date: Aug. 10, 2006

(54) Sideband filtering of directly modulated lasers with feedback loops in optical networks

(75) Inventors: Loukas Paraschis, Mountain View, CA (US); James T. Theodoras II, Plano, TX (US); Ornan Gerstel, Los Altos, CA (US)

Correspondence Address: AKA CHAN LLP / CISCO, 900 LAFAYETTE STREET, SUITE 710, SANTA CLARA, CA, 95050, US

(73) Assignees: Cisco Technology, Inc., San Jose, CA (US); A Corporation of the state of California

(21) Appl. No.: 11/051,699

(22) Filed: Feb. 4, 2005

(51) Int. Cl. H04J 14/02

(52) U.S. Cl. 398/87

(57) ABSTRACT

In a WDM optical network DML signals are sideband filtered to compensate for chirp with a feedback loop carrying signals from a monitor unit which helps maintain the sideband filter offset from a peak output of the DMLs. Network components with filtering characteristics, such as AWGs, can be used as the sideband filters. The monitor units monitor the Q-factors or BERs of the filtered signals and the sideband offset is maintained by temperature control of the sideband filters with respect to the DMLs.

### BACKGROUND OF THE INVENTION

The present invention is related to modulated laser sources for optical networks and, more specifically, to directly modulated lasers (DMLs) in optical networks.

In an optical network the light signal sources are typically semiconductor lasers which are externally modulated, such as shown in FIG. 1A. In this arrangement a modulator, such as a electro-absorptive or Mach-Zehnder modulator, at the output of the semiconductor laser diode receives an input signal and modulates a constant (continuous wave) light signal from the laser diode. However, externally modulated laser sources are expensive and directly modulated lasers (DMLs), by which the semiconductor laser diode receives the input signal directly so that the laser diode's output is the light signal as illustrated in FIG. 1B, would seem desirable. DMLs can be approximately 75% cheaper than externally modulated sources, since the modulator and modulator driver are omitted.

But directly modulated lasers (DMLs) face the well-documented problem of chirp, which is the reason that externally modulated lasers are typically preferred in optical networks. Direct modulation (DM) of a semiconductor laser diode changes the refractive index of the laser's semiconductor substrate as the density of the current carriers changes due to modulation. The resonant wavelength of the laser cavity formed on the substrate shifts during a pulse, i.e., chirp, to effectively spread the range of output wavelengths. In contrast to a laser operating in continuous wave (CW) mode which has a bandwidth determined by the resonant frequency of the lasing cavity, a laser operating in DM mode has a much larger bandwidth due to chirp. This is undesirable, especially for WDM networks in which multiple optical signals having different wavelengths share an optical fiber, each wavelength defining a particular communication channel. Hence WDM (Wavelength Division Multiplexing) is used herein to include any system using optical wavelengths to define channels, such as DWDM (Dense Wave Division Multiplexing). Additionally, increasing optical data rates, with signals at 10 Gb/s in commercial use expected in the near future, impose tighter restrictions on signal dispersion and render DMLs unsuitable as long distance signal sources. Starting with a broadened wavelength bandwidth due to chirp, signals from DMLs suffer greater dispersion as they travel down an optical fiber than signals from CW laser sources which are externally modulated.

Various efforts have been made to overcome chirp in DMLs. Early attempts tried to narrow the laser output spectrum by increasing the laser cavity length which is determined by the length of the semiconductor die. Rather than coating both ends of the die with reflecting materials, the reflective coating on one end of the laser die was left off and replaced by a reflector, a mirror or grating, external to the die to effectively lengthen the laser cavity. Nonetheless, these modified lasers called ECL's (External Cavity Lasers) are expensive since the external reflectors must be precisely aligned and athermalized, and have not gained market acceptance. A variation of the ECL approach of lowering chirp in DMLs with a fiber Bragg grating in place of a discrete grating also has met with little market acceptance. Besides high cost, this approach leaves no room in the laser package for an onboard optical isolator and forces the isolator to be spliced onto the output fiber.

Another effort was to condition the electrical input signal which modulates the semiconductor laser. The electrical signal is “pre-emphasized” and the resulting output electrical signal at the receiver is “de-emphasized.” However, this approach can only compensate for a small amount of chirp and requires a specially matched receiver, which reduces interoperability of network components.

A recent effort to extend the useful range of DMLs is the use of electronic adaptive digital equalization (EDE) at the receiver. This requires an ASIC (Application Specific Integrated Circuit) be added between the receiver's pre-amplifier and clock data recovery (CDR) circuitry, which adds significant costs and power consumption. There are limits to how much signal processing can be used to recover a chirped signal that is heavily dispersed. While EDE can be used to potentially increase distance up to 50%, it would be better to solve the problem at the transmitter, rather than trying to compensate at the receiver.

The present invention solves, or substantially mitigates, the problem of chirp in DML-sourced signals in optical networks efficiently and at relatively low cost so that the advantages of DML sources can be realized.

### SUMMARY OF THE INVENTION

In a WDM optical network having at least one transmitter sending signals to at least one receiver over a network optical fiber, the present invention provides for a DML generating signals for the transmitter; a sideband filter between the transmitter and the receiver, the filtering characteristics of the sideband filter offset from a peak output of the DML compensating for chirp; a monitoring unit between the sideband filter and the receiver, the monitoring unit responsive to the sharpness of DML-generated signals filtered by the sideband filter; and a feedback loop from the monitoring unit for maintaining the offset between the DML and the sideband filter. Network components with filtering characteristics, such as AWGs (Arrayed WaveGuides), can be used as sideband filters. The sideband filter can also be located within the transmitter. Signals on the feedback loop from the monitoring unit, which can monitor the quality (the Q-factor or the BER) of the monitored signals, maintains the offset to minimize chirp of the DML-generated signals.

The present invention also provides for a method of operating a WDM optical network having at least one DML transmitter sending signals to at least one receiver over a network optical fiber. The method has the steps of: sideband filtering the DML transmitter signals with an offset from a peak output of the DML transmitter to compensate for chirp; monitoring the filtered DML transmitter signals; generating feedback signals responsive to sharpness of the monitored signals; and maintaining the offset responsive to the feedback signals.

### BRIEF DESCRIPTION OF THE DRAWINGS

FIG. 1A shows the general organization of an externally modulated laser; FIG. 1B shows the general organization of a directly modulated laser (DML);

FIG. 2A is a graph of the comparative general outputs of externally modulated and directly modulated lasers; FIG. 2B illustrates the general output of a DML and the operation of a Gaussian sideband filter; FIG. 2C is a graph of the Q-factor of DML outputs versus transmission distance with and without sideband filtering;

FIG. 3 is a representation of an optical network mid-span node with AWGs to compensate for the chirp of DML-sourced signals, according to one embodiment of the present invention;

FIG. 4A illustrates the general organization of an add/drop multiplexer having its AWG components used for chirp compensation of DML-sourced signals, according to another embodiment of the present invention; FIG. 4B is a more detailed diagram of the wavelength-selective switch of the FIG. 4A add/drop multiplexer;

FIG. 5 shows the general organization of an optical network in which its transmitter AWG multiplexer and receiver AWG demultiplexer are used for chirp compensation of DML-sourced signals, according to an embodiment of the present invention; and

FIG. 6A illustrates the general organization of an optical network having its DML laser sources controlled in a feedback loop from its receivers to compensate for chirp, according to still another embodiment of the present invention; and FIG. 6B shows the details of the FIG. 6A laser sources in a variation of the FIG. 6A embodiment of the present invention.

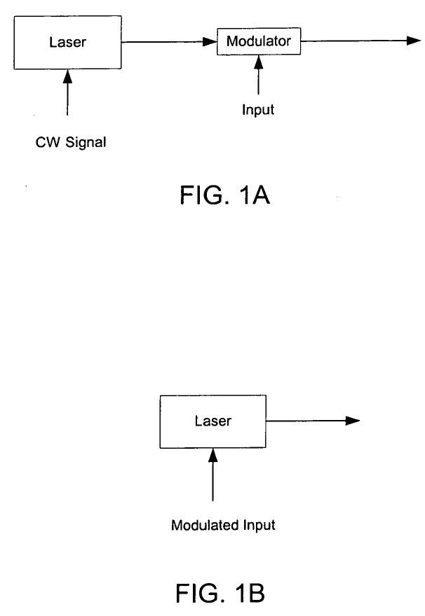

### DESCRIPTION OF SPECIFIC EMBODIMENTS

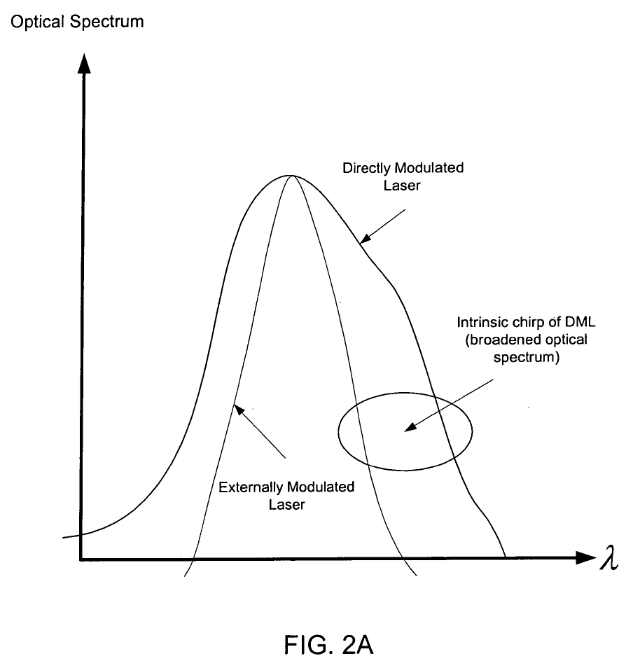

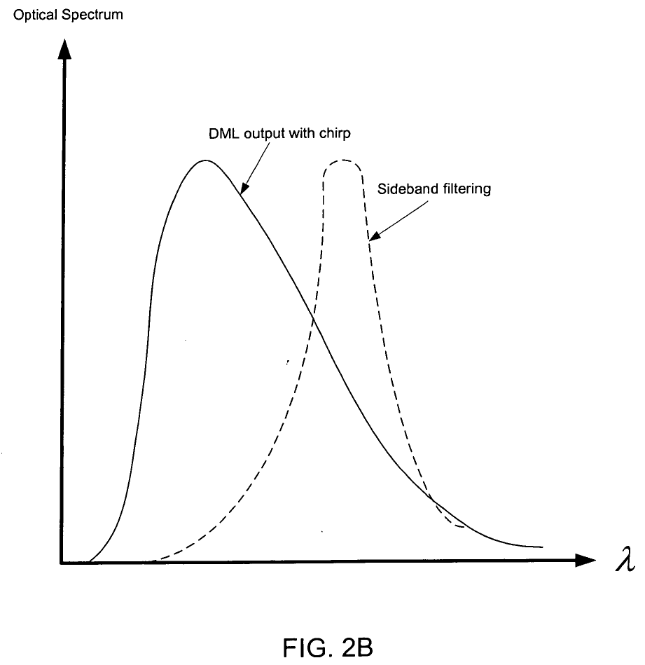

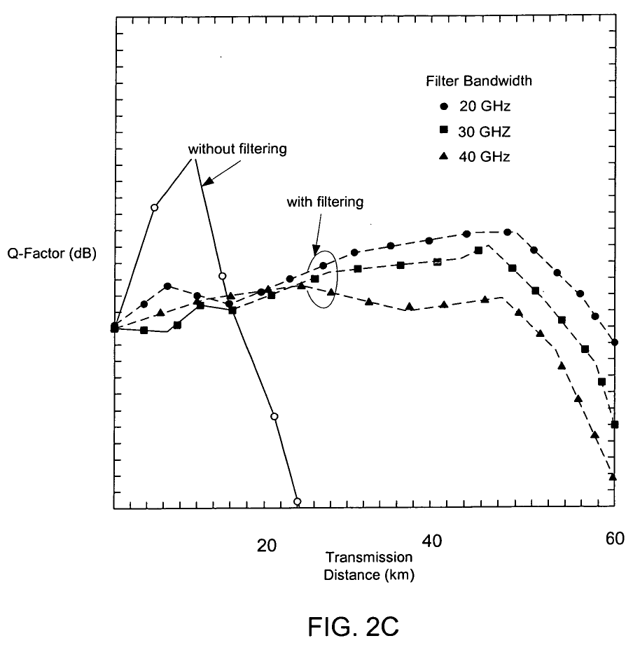

The comparative outputs of externally modified lasers and DMLs are shown in FIG. 2A. It is evident that the output of the externally modulated laser has a much more narrow output bandwidth than the chirp-broadened output of the DML and is more suitable for WDM network signals than signals from a DML source.

However, recent research has pointed to a technique of narrowing DML output bandwidth by sideband filtering. The side lobes of the output spectrum are removed by a narrow optical passband filter offset from the fundamental frequency, i.e., peak output wavelength, of the DML output, or stated more precisely, the slope of the edge of the sideband filter chirps the signal oppositely from the chirp induced by the DML so that the two chirps cancel each other. As shown in FIG. 2B, the DML output for a 10 Gb/s input data signal marked by a solid line is filtered by a sideband filter as illustrated by a dotted line. While the sideband filter shown is Gaussian, almost any shape of the sideband filter, even a filter with only side of its response function, can work. The resulting narrowed output is much more suitable for WDM networks operating at higher data rates and longer transmission distances. Higher data rates pack signal pulses closer in time, but DMLs without output narrowing start with a broadened wavelength bandwidth due to chirp and suffer great dispersion as they travel down an optical fiber. After a relatively short transmission distance, the signal pulses undesirably blur into each other.

FIG. 2C is a graph of the DML output Q-factor, a measurement of the quality of the output signal, versus transmission distance in kilometers. The filtered DML output signals. at filtered bandwidths of 20, 30 and 40 GHz, maintain a narrow bandwidth, i.e., a high Q-factor value, over significantly longer distances than the unfiltered DML output signals.

The advantages of sideband filtering of a DML is also described in U.S. Patent Application Publication No. 2004/0114844, entitled, “DIRECTLY MODULATED DISTRIBUTED FEEDBACK LASER DIODE OPTICAL TRANSMITTER APPLYING VESTIGAL SIDE BAND MODULATION,” and published Jun. 17, 2004. In this case the output of a distributed feedback laser diode which is directly modulated is sideband filtered for an improved output.

However, the arrangements described above simply add a sideband filter to a laser diode. No measures are taken to ensure that the offset for filtering the sideband is maintained as the ambient conditions of the laser sources change. On the other hand, the present invention controls and maintains the filter offset with a feedback loop and employs elements which already exist in an optical network. Costs are minimized even though performance is enhanced.

In one aspect of the present invention, the filtering characteristics of AWGs (Arrayed WaveGuides) are used. AWGs are often employed as optical splitters and optical combiners in optical networks The center wavelength of AWGs, typically in the form of planar circuits, are often protected against changes in temperature by heating/cooling units with feedback control loops maintaining the network optical signals on the WDM grid of specified wavelength channels. In the present invention the heating/cooling units and the feedback control loops also control the offset between the network signals generated from DML sources and the AWG filtering grid.

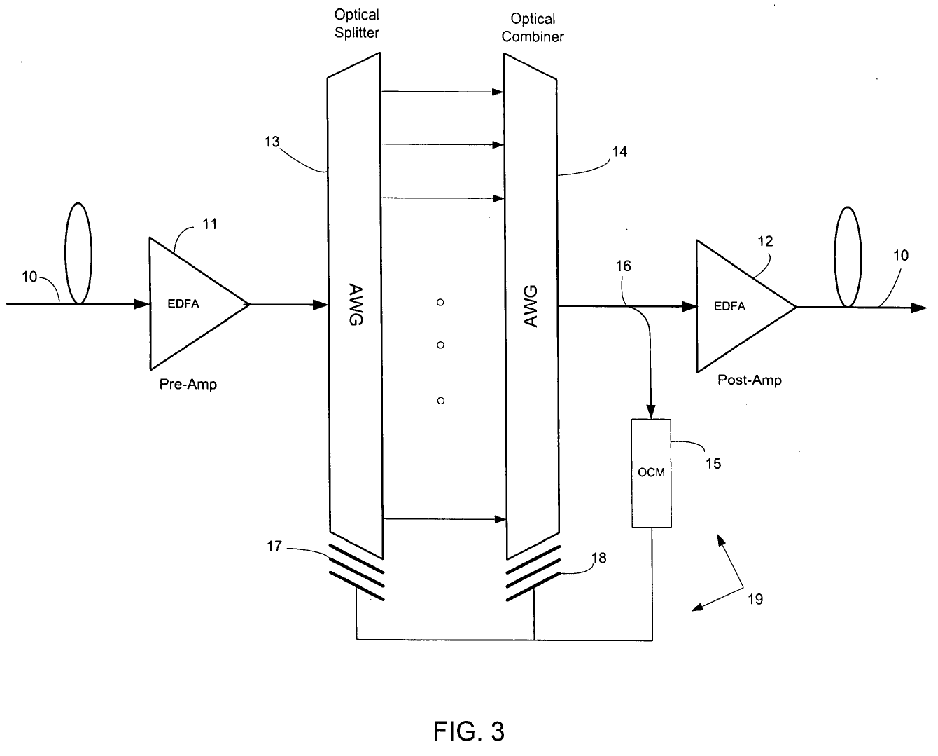

This is illustrated in FIG. 3 in which AWGs 13 and 14 appear as a mid-span DML chirp compensator for DML source signals carried on a network optical fiber 10. The AWG 13 splits the signals received on the optical fiber 10 into WDM channels and the AWG 14 recombines the WDM channel signals back onto the optical fiber 10. A pre-amplification EDFA (Erbium-Doped Fiber Amplifier) 11 and post-amplification EDFA 12 maintain signal strength on the optical fiber 10 against the insertion losses of the AWGs and fiber loss. A tap 16 diverts part of the recombined signals from the AWG 14 to an OCM (Optical Channel Monitor) 15 which monitors the Q-factor of the WDM signals from the AWG 14 and sends a control signal to a heating/cooling unit 17 attached to the AWG 13 and a heating/cooling unit 18 attached to the AWG 14. The heating/cooling units may be simple resistive heating elements or constructed from TEC (thermo-electric coupler) devices often used in optical network component devices. This feedback control loop 19 controls the temperatures of the AWGs 13 and 14 so that the AWG filtering characteristics are properly offset from the peak output wavelength into the output sidebands of the DML laser sources and maintained there. The OCM 15 may monitor the variance of only one WDM channel or the average of all the WDM channels to maintain the proper frequency offset for the sideband filtering of the DML sources.

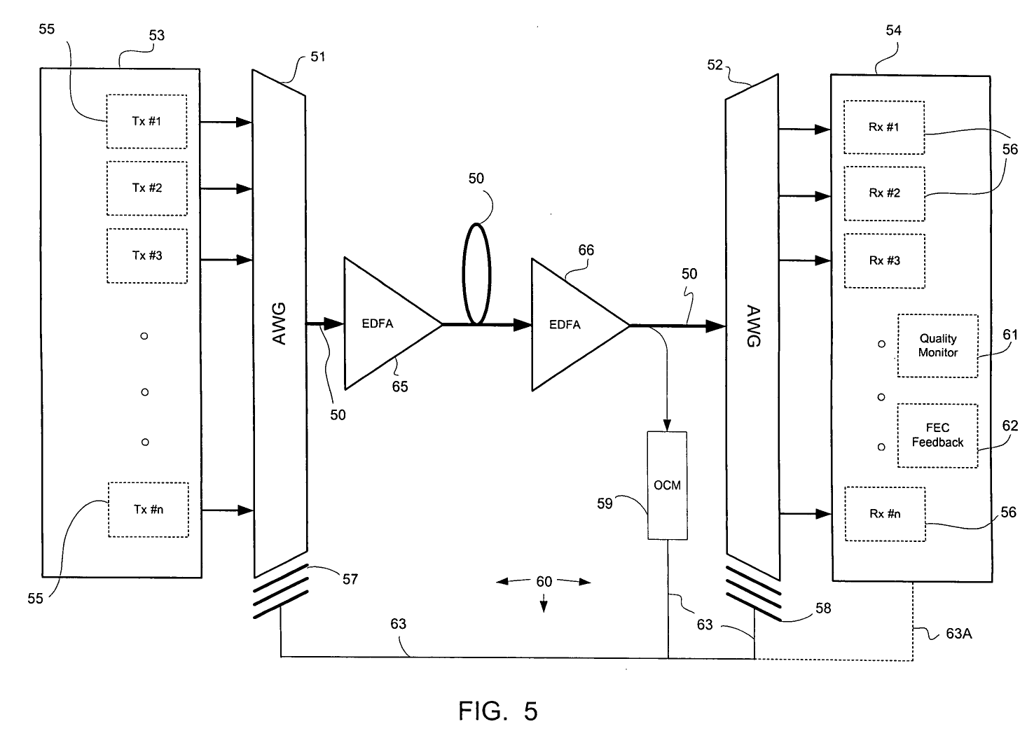

Alternatively, instead of the heating (or cooling) of both AWGs 13 and 14 under the feedback control of the OCM 15, only one AWG might be used. Furthermore, the feedback control signal may arise from signal monitoring units in the receiver unit, as described below with respect to FIG. 5.

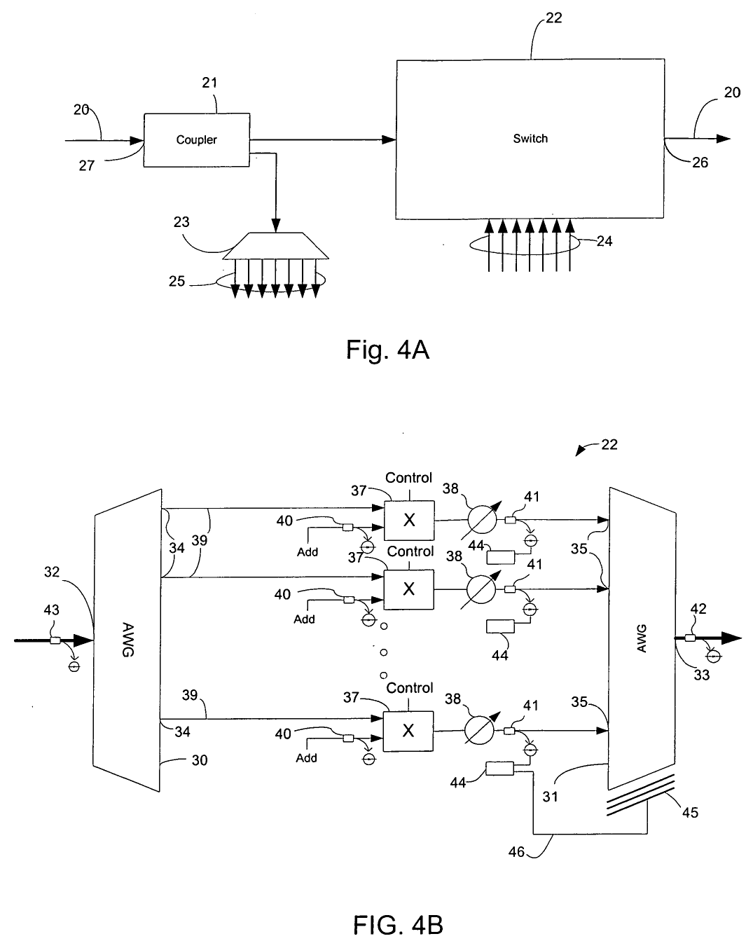

Furthermore, AWGs are often constituent elements of other components in optical networks and may also be used for sideband filtering of DML signal sources. FIGS. 4A and 4B illustrate one such example. FIG. 4A illustrates the general organization of an reconfigurable optical add/drop multiplexer, the subject of U.S. patent application Ser. No. 10/959,366, entitled “OPTICAL ADD/DROP MULTIPLEXER WITH RECONFIGURABLE ADD WAVELENGTH SELECTIVE SWITCH,” filed Oct. 6, 2004, assigned to the present assignee and incorporated by reference herein. Connected to a network optical fiber 20 which carries WDM signals, the reconfigurable optical add/drop multiplexer has a coupler 21, a demultiplexer element 23 for the drop function, and a wavelength-selective switch 22 for the add function. The coupler 21, which has its input terminal 27 connected to the optical fiber 20, splits off a portion of the WDM signals carried on the optical fiber 20. In turn, the demultiplexer element 23, such as a Gaussian AWG, separates the split-off signals into constituent WDM channels at drop terminals 25.

The wavelength-selective switch 22 has the AWGs of interest. The switch 22, which has its output terminal 26 connected to the network optical fiber 20, receives the passed signals from the coupler 21 and signals to be added from add terminals 24. As shown in FIG. 4B, the wavelength-selective switch 22 has an AWG demultiplexer 30, a AWG multiplexer 31 and a plurality of 2×1 switches 37. The WDM signals received from the coupler 21 are separated by the AWG demultiplexer 30 at its output terminals 34 and sent on signal paths 39. While only three paths 39 are shown, it is understood that there are preferably 32 paths for each WDM channel. Each of the signal paths 39 are connected to one of the input terminals 35 of the multiplexer element 31 through a 2×1 switch 37. Each switch 37 has two input terminals, the first connected to its respective output terminal 34 of the demultiplexer 30 and the second input terminal to an add terminal 24. Responsive to a signal on a control line, each switch 37 operates to either pass signals from the demultiplexer output terminal 34 to the multiplexer input terminal 35 or to add signals from its add terminal 24 to the multiplexer input terminal 35. A VOA (Variable Optical Attenuator) 38 controls the power of the signal leaving the switch 37. Control lines and signals to the VOAs 38 are not shown in the drawings.

Optical power is monitored throughout the switch 22 at monitoring nodes 40-44, which are each connected to photodiodes (shown symbolically). The photodiodes generate electrical signals indicative of the optical power of the optical signals at the monitoring nodes so that power on the paths of the wavelength-selective switch 22 and through the constituent switches 37 is monitored through the monitoring nodes and independently controlled by the VOAs 38. Further details of the described add/drop multiplexer may be found in the above-mentioned patent application.

Of particular interest to the present invention are the monitoring nodes 41 at the output terminals of the switches 37. Q-factor units 44 are connected to the photodiodes for the nodes 41. The units 44 provide control signals through a feedback line 46 to a heating/cooling unit 45 for the AWG multiplexer 31. Only one feedback loop is shown, but it is understood that the other units 44 also provide control signals for the heating/cooling unit 45 so that the AWG multiplexer 31 maintains the proper frequency offset for the sideband filtering of the DML-sourced optical signals on the network.

Alternatively, only one feedback loop from one monitoring node 41 could be used, or a second heating/cooling unit for the AWG demultiplexer 30 could be used to maintain the sideband filtering offset, similar to the arrangement in FIG. 3.

Note that the AWG is used for multiple purposes—one as a constituent component of the wavelength-selective switch 22 and the other as a sideband filter for DML signals. Still another example of the efficient usage of AWGs is illustrated in FIG. 5 where a network transmitter AWG multiplexer and a network receiver AWG demultiplexer are used as sideband filters for DML source signals.

In this embodiment a transmitter unit 53 with DML laser sources 55 for each WDM channel sends optical signals over a network optical fiber 50 to a receiver unit 54 with individual receivers 56 for each WDM channel. An AWG 51 acts as the multiplexer for the transmitter unit 53 to combine the signals from laser sources 55 for transmission onto the optical fiber 50 and an AWG 52 acts as the demultiplexer for the receiver unit 54 to separate the signals for the receivers 56. EDFAs 65 and 66 represent the various optical amplifiers for the signals on the optical fiber 50.

Filtering of the DML source signals is performed by the AWGs 51 and 52. In the same manner as described earlier, a feedback loop 60 formed by a OCM unit 59 and control line 63 to heating/cooling units 57 and 58 attached to the AWGs 51 and 52 respectively provides for effective sideband filtering the DML-sourced signals on the optical fiber 50. Alternatively, the Q-factor monitoring of the signals can be monitored by a quality monitor unit 61 or the BER (Bit Error Rate) of the received signals can be calculated by a FEC (Forward Error Correction) unit 62 in the receiver unit 54. BER calculation provides for digital indication of the sharpness of the DML-sourced signals. The units 61 or 62 checks the signals entering the receiver unit 54 for the receivers 56. The dotted line 63A in FIG. 5 shows the corresponding control line for the feedback loop 60 by which these units 61 or 62 control the heating and cooling of the AWGs 51 and 52.

The quality monitor unit 61 or FEC unit 62 can be implemented by a standalone integrated circuit or by a dedicated circuit block inside an ASIC (Application Specific Integrated Circuit). With Forward Error Correction, an FEC unit (not shown) at the transmitter 53 encodes the transmitted data stream, and then the FEC unit 62 decodes the data stream at the receiver, correcting any errors discovered in the codes. While correcting errors, it keeps a count of the errors, the “bit-error rate,” or BER, which is a direct indication of the Q-factor of the link and which may be used as feedback for the sideband filter heater control loop 60.

The feedback signal, whether from the quality monitor 61, FEC unit 62 or OCM unit 59, is a digital signal that may be transmitted over the network OSC (Optical Supervisory Channel) which carries all information between nodes on a WDM network, or simply routed over a separate data link which need not be a high-speed link. By their very nature, operations with temperature control loops work very slowly.

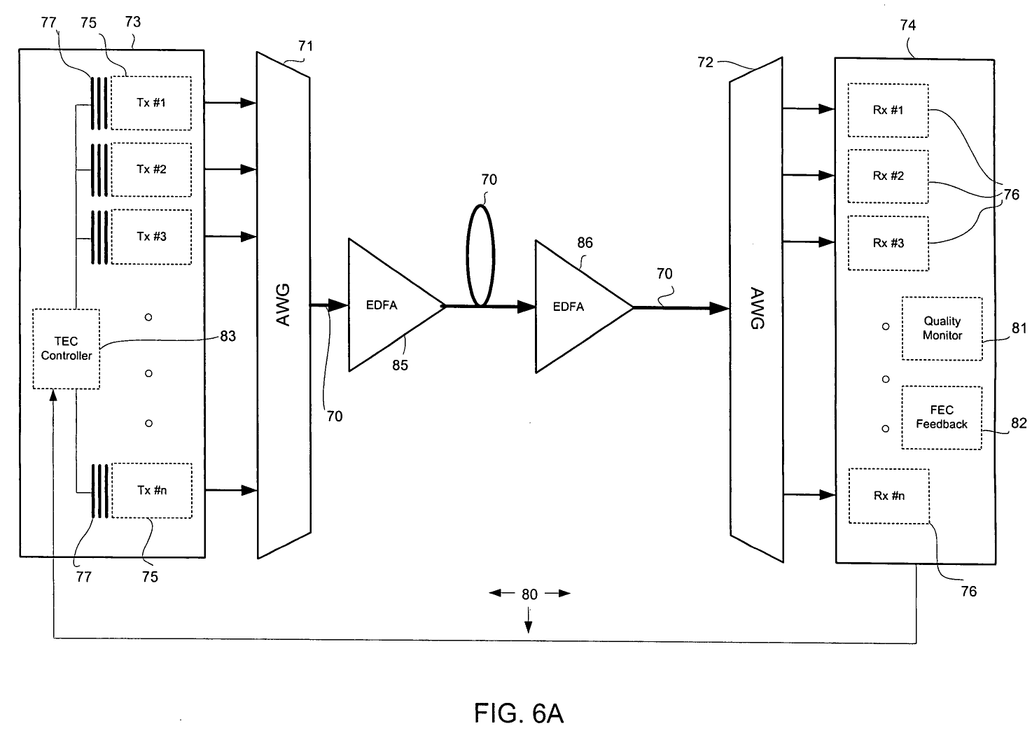

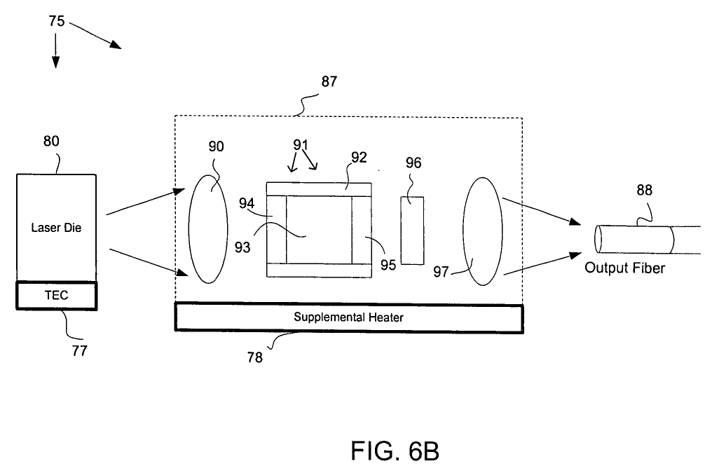

FIG. 6A illustrates another representational network having a similar arrangement to that of FIG. 5. A transmitter unit 73 with DML laser sources 75 for each WDM channel sends optical signals over a network optical fiber 70 to a receiver unit 74 with individual receivers 76 for each WDM channel. An AWG 71 acts as the multiplexer for the transmitter unit 73 to combine the signals from DML laser sources 75 for transmission onto the optical fiber 70 and an AWG 72 acts as the demultiplexer for the receiver unit 74 to separate the signals for the receivers 76. EDFAs 85 and 86 represent the various optical amplifiers for the signals on the optical fiber 70. The quality of the DML-sourced signals are monitored by a quality monitor unit 81, which checks the Q-factor, or a FEC (Forward Error Correction) unit 82, which calculates the BER (Bit Error Rate), of the received signals at the receiver unit 74.

However, instead of controlling the heating and cooling of the AWGs in the optical network, a feedback loop 80 controls the heating (or cooling) of the DML laser sources 75 themselves. In the previous arrangements, it had been assumed that the output of the DML laser sources were stabilized in some manner. Indeed, semiconductor lasers typically have some heating/cooling feedback control to prevent the peak output wavelength of the laser from wandering over time. In the present invention the control of the heating/cooling of the laser sources 75 is performed by the described feedback loop 80 and a TEC (Thermo-Electric Coupler) controller 83 to maintain the proper sideband offset between a sideband filter and the laser diode in the laser sources 75. The TEC controller 83 controls heating or cooling of the TEC units 77 for each laser source 75.

FIG. 6B illustrates the general assembly of each laser source 75 which has a semiconductor laser diode die 80, a collimator-isolator assembly 87 and a sideband filter 96. The die 80 is mounted on a TEC unit 77 and the assembly 87 is mounted on a supplemental TEC unit 78. The assembly 87 has a lens 90 which receives the light from the die 80 and collimates it for an optical isolator subassembly 91 formed by a magnetic ring 92 which holds a garnet slice 93 to form a Faraday rotator. In either side of the garnet slice 93 is a birefringent polarizer 94 and analyzer 95. Collimated light can travel in only one direction (from the die 80 to the fiber 88) through the isolator subassembly 91. The sideband filter 96, such as a thin-film filter (TFF), with the proper offset receives the light from the subassembly 91 and an output lens 97 refocuses the collimated light into the facet 89 of the output fiber 88. The AWG 71 combines the light of the output fibers 88 from the plurality of laser sources 75 for transmission on the network optical fiber 70, as shown in FIG. 6A.

Operationally, the TEC unit 78 maintains the filter 96 at a constant temperature and the TEC unit 77 varies the temperature of the laser die 98 in response to the feedback signals on the loop 80 from the receiver unit 74 to keep the proper sideband offset. Alternatively, the temperature of the TEC unit 77 can be kept constant and the temperature of the filter 96 can be varied under control of the feedback loop 80.

Hence the present invention provides for a efficient way of using DMLs as optical network laser sources. Components which are commonly found in optical networks are used as part of a feedback loop to control the offset of sideband filtering of the output of the DML sources. Chirp in DML-sourced signals are minimized at minimal cost so that DML sources are now practical in optical networks.

Therefore, while the description above provides a full and complete disclosure of the preferred embodiments of the present invention, various modifications, alternate constructions, and equivalents will be obvious to those with skill in the art. Thus, the scope of the present invention is limited solely by the metes and bounds of the appended claims.

1. In a WDM optical network having at least one transmitter sending signals to at least one receiver over a network optical fiber, at least a portion of said optical network comprising
a DML generating signals for said at least one transmitter;
a sideband filter between said at least one transmitter and said at least one receiver, filtering characteristics of said sideband filter offset from a peak output of said DML to compensate for chirp;
a monitoring unit between said sideband filter and said at least one receiver unit, said monitoring unit responsive to sharpness of DML-generated signals filtered by said sideband filter; and
a feedback loop from said monitoring unit for maintaining said offset between said DML and said sideband filter.

2. The WDM optical network portion of claim 1 wherein said sideband filter comprises a first AWG, said first AWG having an attached heating/cooling unit connected to said feedback loop and responsive to said monitoring unit.

3. The WDM optical network portion of claim 2 wherein said first AWG comprises a demultiplexer having an input terminal connected to said network optical fiber and a plurality of output terminals; and said sideband filter further comprises
a second AWG comprising a multiplexer having a plurality of input terminals coupled to said output terminals of said first AWG and an output terminal connected to said network optical fiber.

4. The WDM optical network portion of claim 3 wherein said second AWG has an attached heating/cooling unit connected to said feedback loop and responsive to said monitoring unit.

5. The WDM optical network portion of claim 2 wherein said first AWG comprises a multiplexer having an output terminal connected to said network optical fiber and a plurality of input terminals; and said sideband filter further comprises
a second AWG comprising a demultiplexer having a plurality of output terminals coupled to said input terminals of said first AWG and an input terminal connected to said network optical fiber.

6. The WDM optical network portion of claim 5 further comprising a plurality of optical switches, each optical switch having a switch terminal and connected between an output terminal of said second AWG and an input terminal of said first AWG, and wherein said first AWG, said second AWG and said plurality of optical switches comprise a wavelength-selective switch.

7. The WDM optical network portion of claim 6 wherein said monitoring unit comprises a plurality of wavelength monitoring units, each wavelength monitoring unit connected between an output terminal of said second AWG and an input terminal of said first AWG.

8. The WDM optical network portion of claim 6 further comprising
a coupler connected to said network optical fiber between said transmitter and said second AWG, said coupler splitting signals from said network optical fiber to a coupler output terminal;
a demultiplexer connected to said coupler output terminal and having a plurality of output terminals forming Drop terminals; and wherein
said switch terminals form Add terminals for said wavelength-selective switch;
whereby said coupler and said wavelength-selective switch form a reconfigurable add/drop multiplexer with sideband filtering functions for DML signals.

9. The WDM optical network portion of claim 3 further comprising
a plurality of optical switches, each optical switch having a switch terminal and connected between an output terminal of said first AWG and an input terminal of said second AWG, and wherein said first AWG, said second AWG and said plurality of optical switches comprise a wavelength-selective switch;
a coupler connected to said network optical fiber between said transmitter and said second AWG, said coupler splitting signals from said network optical fiber to a coupler output terminal;
a demultiplexer connected to said coupler output terminal and having a plurality of output terminals forming Drop terminals; and wherein
said switch terminals form Add terminals for said wavelength-selective switch;
whereby said coupler and said wavelength-selective switch form a reconfigurable add/drop multiplexer with sideband filtering functions for DML signals.

10. The WDM optical network portion of claim 2 wherein said WDM optical network further has a plurality of transmitters sending signals to a plurality of receivers over said network optical fiber, a DML generating signals for each transmitter, and wherein
said first AWG forms a multiplexer having a plurality of input terminals, each first multiplexer input terminal connected to one of said transmitters, and an output terminal connected to said network optical fiber; and further comprising
a second AWG forming a demultiplexer having an input terminal connected to said network optical fiber and a plurality of output terminals, each second multiplexer output terminal connected to one of said receivers.

11. The WDM optical network portion of claim 10 wherein said second AWG has an attached heating/cooling unit connected to said feedback loop and responsive to said monitoring unit.

12. The WDM optical network portion of claim 11 wherein said monitoring unit is connected at said input terminal of said second AWG.

13. The WDM optical network portion of claim 11 wherein said monitoring unit is connected to each output terminal of said second AWG, said monitoring unit monitoring a Q-factor of each signal to each receiver.

14. The WDM optical network portion of claim 11 wherein said monitoring unit is connected to each output terminal of said second AWG, said monitoring unit calculating a BER of each signal to each receiver.

15. The WDM optical network portion of claim 11 wherein said feedback loop comprises an FEC of said WDM optical network.

16. The WDM optical network portion of claim 2 wherein said WDM optical network further has a plurality of transmitters sending signals to a plurality of receivers over said network optical fiber, a DML generating signals for each transmitter, and wherein
said first AWG forms a demultiplexer having a plurality of output terminals, each first multiplexer output terminal connected to one of said receivers, and an input terminal connected to said network optical fiber; and further comprising
a second AWG forming a multiplexer having an output terminal connected to said network optical fiber and a plurality of input terminals, each second multiplexer input terminal connected to one of said transmitters.

17. The WDM optical network portion of claim 1 wherein said monitoring unit monitors a Q-factor of said DML-generated signals.

18. The WDM optical network portion of claim 1 wherein monitoring unit calculates a BER of said DML-generated signals.

19. The WDM optical network portion of claim 1 wherein said at least one transmitter comprises said sideband filter, said sideband filter at the output of said DML, and wherein said feedback loop maintains said offset between said DML and said sideband filter by controlling a temperature difference between said DML and said filter.

20. The WDM optical network portion of claim 19 wherein said DML has a first heating/cooling unit attached thereto, said first heating/cooling unit connected to said feedback loop and responsive to said monitoring unit, and said sideband filter has a second heating/cooling unit attached thereto, said second heating/cooling unit maintaining said sideband filter at a constant temperature.

21. The WDM optical network portion of claim 19 wherein said monitoring unit monitors a Q-factor of said DML-generated signals.

22. The WDM optical network portion of claim 19 wherein said monitoring unit calculates a BER of said DML-generated signals.

23. The WDM optical network portion of claim 19 wherein said feedback loop comprises an FEC of said WDM optical network.

24. A method of operating a WDM optical network having at least one DML transmitter sending signals to at least one receiver over a network optical fiber, said method comprising
sideband filtering said DML transmitter signals with an offset from a peak output of said DML transmitter to compensate for chirp;
monitoring said filtered DML transmitter signals;
generating feedback signals responsive to sharpness of monitored signals; and
maintaining said offset responsive to said feedback signals.

25. The method of claim 24 wherein said sideband filtering step comprises
using a network component between said DML transmitter and said receiver, said network component having filtering characteristics responsive to temperature changes; and wherein said maintaining step comprises
heating and cooling said network component responsive to said feedback signals.

26. The method of claim 25 wherein said network component comprises a first AWG, and said heating and cooling step comprises heating and cooling said first AWG.

27. The method of claim 26 wherein said first AWG is connected as a demultiplexer having an input terminal connected to said network optical fiber and a plurality of output terminals connected to a plurality of input terminals of a second AWG connected as a multiplexer, said second AWG having an output terminal connected to said network optical fiber.

28. The method of claim 27 wherein said heating and cooling step comprises heating and cooling said second AWG.

29. The method of claim 26 comprising
operating a plurality of optical switches, each optical switch connected between a first AWG output terminal and a second AWG input terminal, wherein said first AWG, said second AWG and said plurality of optical switches comprises a wavelength-selective switch.

30. The method of claim 26 wherein said first AWG is connected as a multiplexer having an output terminal connected to said network optical fiber and a plurality of input terminals connected to a plurality of output terminals of a second AWG connected as a demultiplexer, said second AWG having an input terminal connected to said network optical fiber.

31. The method of claim 30 comprising
operating a plurality of optical switches, each optical switch connected between a first AWG input terminal and a second AWG output terminal, wherein said first AWG, said second AWG and said plurality of optical switches comprises a wavelength-selective switch.

32. The method of claim 26 wherein said WDM optical network further has a plurality of DML transmitters sending signals to a plurality of receivers over said network optical fiber, wherein said first AWG is connected as a multiplexer having an output terminal connected to said network optical fiber and a plurality of input terminals connected to said plurality of DML transmitters, and further comprising a second AWG connected as a demultiplexer having an input terminal connected to said network optical fiber and a plurality of output terminals connected to said plurality of receivers.

33. The method of claim 32 wherein said heating and cooling step comprises heating and cooling said second AWG.

34. The method of claim 33 wherein said monitoring step comprises monitoring signals at said input terminal of said second AWG.

35. The method of claim 33 wherein said monitoring step comprises monitoring signals at each output terminal of said second AWG for a Q-factor.

36. The method of claim 33 wherein said monitoring step comprises monitoring signals at each output terminal of said second AWG for a BER.

37. The method of claim 33 further comprising sending said feedback signals on an FEC of said WDM optical network.

38. The method of claim 26 wherein said WDM optical network further has a plurality of DML transmitters sending signals to a plurality of receivers over said network optical fiber, wherein said first AWG is connected as a demultiplexer having an input terminal connected to said network optical fiber and a plurality of output terminals connected to said plurality of receivers, and further comprising a second AWG connected as a multiplexer having an output terminal connected to said network optical fiber and a plurality of input terminals connected to said plurality of transmitters.

39. The method of claim 38 wherein said monitoring step comprises monitoring said DML transmitter signals for a Q-factor.

40. The method of claim 38 wherein said monitoring signals comprises monitoring said DML transmitter signals for a BER.

41. The method of claim 38 wherein said sideband filtering step comprises performing said step in said at least one DML transmitter, said offset maintaining step comprises controlling a temperature difference between a DML and a sideband filter in said DML transmitter.

42. The method of claim 41 wherein said maintaining step comprises maintaining said sideband filter at a constant temperature.

43. The method of claim 41 wherein said monitoring step comprises monitoring said DML transmitter signals for a Q-factor

44. The method of claim 41 wherein said monitoring signals comprises monitoring said DML transmitter signals for a BER.

45. The method of claim 41 further comprising sending said feedback signals on an FEC of said WDM optical network.

46. In a WDM optical network having at least one DML transmitter sending signals to at least one receiver over a network optical fiber, at least a portion of said optical network comprising
means for sideband filtering said DML transmitter signals with an offset from a peak output of said DML transmitter;
means for monitoring said filtered DML transmitter signals;
means for generating feedback signals responsive to sharpness of monitored signals; and
means for maintaining said offset responsive to said feedback signals.

47. The WDM optical network portion of claim 46 wherein sideband filtering means comprises
a network component between said DML transmitter and said receiver, said network component having filtering characteristics responsive to temperature changes; and wherein maintaining means comprises
means for heating and cooling said network component responsive to said feedback signals.

48. The WDM optical network portion of claim 47 wherein said network component comprises a first AWG, and said heating and cooling means comprises a TEC attached to said first AWG.

49. The WDM optical network portion of claim 48 wherein said first AWG is connected as a demultiplexer having an input terminal connected to said network optical fiber and a plurality of output terminals connected to a plurality of input terminals of a second AWG connected as a multiplexer, said second AWG having an output terminal connected to said network optical fiber.

50. The WDM optical network portion of claim 49 wherein said heating and cooling means comprises a TEC attached to said second AWG.

51. The WDM optical network portion of claim 48 comprising
a plurality of optical switches, each optical switch connected between a first AWG output terminal and a second AWG input terminal, wherein said first AWG, said second AWG and said plurality of optical switches comprises a wavelength-selective switch.

52. The WDM optical network portion of claim 48 wherein said first AWG is connected as a multiplexer having an output terminal connected to said network optical fiber and a plurality of input terminals connected to a plurality of output terminals of a second AWG connected as a demultiplexer, said second AWG having an input terminal connected to said network optical fiber.

53. The WDM optical network portion of claim 52 comprising
a plurality of optical switches, each optical switch connected between a first AWG input terminal and a second AWG output terminal, wherein said first AWG, said second AWG and said plurality of optical switches comprises a wavelength-selective switch.

54. The WDM optical network portion of claim 48 wherein said WDM optical network further has a plurality of DML transmitters sending signals to a plurality of receivers over said network optical fiber, wherein said first AWG is connected as a multiplexer having an output terminal connected to said network optical fiber and a plurality of input terminals connected to said plurality of DML transmitters, and further comprising a second AWG connected as a demultiplexer having an input terminal connected to said network optical fiber and a plurality of output terminals connected to said plurality of receivers.

55. The WDM optical network portion of claim 54 wherein said heating and cooling means comprises a TEC attached to said second AWG.

56. The WDM optical network portion of claim 55 wherein said monitoring means monitors signals at said input terminal of said second AWG.

57. The WDM optical network portion of claim 55 wherein said monitoring means monitors signals at each output terminal of said second AWG for a Q-factor.

58. The WDM optical network portion of claim 55 wherein said monitoring means monitors signals at each output terminal of said second AWG for a BER.

59. The WDM optical network portion of claim 55 further comprising means for sending said feedback signals on an FEC of said WDM optical network.

60. The WDM optical network portion of claim 48 wherein said WDM optical network further has a plurality of DML transmitters sending signals to a plurality of receivers over said network optical fiber, wherein said first AWG is connected as a demultiplexer having an input terminal connected to said network optical fiber and a plurality of output terminals connected to said plurality of receivers, and further comprising a second AWG connected as a multiplexer having an output terminal connected to said network optical fiber and a plurality of input terminals connected to said plurality of transmitters.

61. The WDM optical network of claim 60 wherein said monitoring means monitors said DML transmitter signals for a Q-factor.

62. The WDM optical network portion of claim 60 wherein said monitoring means monitors said DML transmitter signals for a BER.

63. The WDM optical network portion of claim 60 wherein said sideband filtering means is in said at least one DML transmitter and said offset maintaining means controls a temperature difference between a DML and a sideband filter in said DML transmitter.

64. The WDM optical network portion of claim 63 wherein said maintaining means maintains said sideband filter at a constant temperature.

65. The WDM optical network portion of claim 63 wherein said monitoring means monitors said DML transmitter signals for a Q-factor

66. The WDM optical network portion of claim 63 wherein said monitoring means monitors said DML transmitter signals for a BER.

67. The WDM optical network portion of claim 63 further comprising means for sending said feedback signals on an FEC of said WDM optical network.
